(19) United States
(12) Patent Application Publication
(10) Pub. No.: US 2025/0081996 A1
(43) Pub. Date: Mar. 13, 2025

(54) FLAVOR MODIFYING COMPOSITION

(71) Applicants: CORN PRODUCTS DEVELOPMENT, INC., WESTCHESTER, IL (US); PURECIRCLE SDN BHD, BANDAR ENSTEK (MY)

(72) Inventors: Kasi SUNDARESAN, Bridgewater, NJ (US); Maryam SAYEED, Bridgewater, NJ (US); Sharon BENDER, Bridgewater, NJ (US)

(21) Appl. No.: 18/294,393

(22) PCT Filed: Aug. 5, 2022
(86) PCT No.: PCT/US2022/039497

§ 371 Date: Feb. 1, 2024

Related U.S. Application Data
(60) Provisional application No. 63/229,744, filed on Aug. 5, 2021.

(51) Int. Cl. A23L 27/30; A23L 27/00

(52) U.S. Cl. CPC A23L 27/36; A23L 27/84; A23L 27/88

(57) ABSTRACT

A food or beverage product is provided comprising a steviol glycoside composition, said composition comprising rebaudioside A (reb A), stevioside, and rebaudioside C (reb C), wherein the steviol glycoside composition is present in an amount below its sweetness threshold. It is found that the food or beverage product has a modified or enhanced flavor compared to a food or beverage product not comprising the steviol glycoside composition.

### CROSS-REFERENCE TO RELATED APPLICATION

The present application claims the benefit of priority under 35 U.S.C. § 119(e) of U.S. Provisional Application Ser. No. 63/229,744, filed on Aug. 5, 2021, the entire disclosure of which is incorporated herein by reference.

### TECHNICAL FIELD

The invention relates to food and beverage products comprising steviol glycoside compositions. The invention further relates to a method of preparing a food product or beverage product. The invention further relates to the use of the steviol glycoside compositions.

### BACKGROUND

Steviol glycosides are a class of compounds found in the leaves of Stevia rebaudiana Bertoni, a perennial shrub of the Asteraceae (Compositae) family native to certain regions of South America. They are characterized structurally by a single base, steviol, differing by the presence of carbohydrate residues at positions C13 and C19. They accumulate in Stevia leaves, composing approximately 10%-20% of the total dry weight. On a dry weight basis, the four major glycosides found in the leaves of Stevia typically include stevioside (9.1%), rebaudioside A (3.8%), rebaudioside C (0.6-1.0%) and dulcoside A (0.3%). Other known steviol glycosides include rebaudiosides B, C, D, E, F, G, H, I, J, L, K, M, N and O, steviolbioside and rubusoside. Structurally, the diterpene glycosides are characterized by a single core structure, steviol, and differ by the presence of carbohydrate residues at positions C13 and C19.

Steviol glycosides are commonly used as high intensity sweeteners. High intensity sweeteners possess a sweetness level that is many times greater than the sweetness level of sucrose. They are essentially non-caloric and are commonly used in diet and reduced-calorie products, including foods and beverages. High intensity sweeteners do not elicit a glycemic response, making them suitable for use in products targeted to diabetics and others interested in controlling for their intake of carbohydrates. The benefits of steviol glycosides are that they have been found to be between 30 and 320 times sweeter than sucrose, and that steviol glycosides can be labeled as “natural flavors”, due to being extracted from the Stevia leaves. Such “natural flavors” may be preferred by consumers.

Flavorings with Modifying Properties (FMPs) are widely used by the flavor industry to modify or enhance the flavor profile of a flavoring and the food to which it is added. In the last few years, the development of new FMPs has increased to help address consumer desire for healthy food alternatives, including reductions in sugar and salt, without compromising flavor. FMPs may not necessarily have or impart a specific characteristic flavor of their own but can modify the flavor profile by altering flavor attributes such as intensifying specific flavor characteristics (e.g., perceived fruitiness), reducing specific flavor characteristics, masking of off-notes or bitterness, or changing the time onset and duration of the perception of specific aspects of the flavor profile. FMPs are generally used at a concentration below which the inherent taste is present. Such taste can be for example sour, salty or sweet.

WO 2017/075034 discloses steviol glycoside compositions as sugar alternatives.

WO 2018/109464 discloses the use of allulose in a low amount to modify or enhance a flavor of a food or beverage product. However, allulose only is about 70% as sweet as sugar. Additionally, allulose only occurs in small quantities naturally.

There remains a need for flavor modifying compositions which can be used at low concentrations. There also remains a need for flavor modifying compositions which may be labelled as “natural flavor”.

### SUMMARY

The present invention provides a food or beverage product comprising a steviol glycoside composition, said composition comprising rebaudioside A (reb A), stevioside, and rebaudioside C (reb C), wherein the steviol glycoside composition is present in an amount below its sweetness threshold.

The present invention further provides a food or beverage product comprising 40-48 wt % rebaudioside A (reb A), 17-20 wt. % stevioside, and 11-13 wt. % rebaudioside C (reb C) based on the total amount of steviol glycosides in the food or beverage product.

The present invention further provides a method of preparing a food or beverage product comprising including in said food or beverage product a composition comprising rebaudioside A (reb A), stevioside, and rebaudioside C (reb C).

The present invention further provides a use of a steviol glycoside composition comprising rebaudioside A (reb A), stevioside, and rebaudioside C (reb C) as a flavor modifying or flavor enhancing agent.

### DETAILED DESCRIPTION

The present invention provides a food or beverage product comprising a steviol glycoside composition, said composition comprising rebaudioside A (reb A), stevioside, and rebaudioside C (reb C), wherein the steviol glycoside composition is present in an amount below its sweetness threshold.

As used herein, the abbreviation term “reb” refers to “rebaudioside”. Both terms have the same meaning and may be used interchangeably.

As used herein, the term “steviol glycoside(s)” refers to a glycoside of steviol. Steviol glycosides are diterpene glycosides which are characterized by a single core structure, steviol, and differ by the presence of carbohydrate residues at positions C13 and C19. Steviol glycosides can be natural or made by enzymatic conversion. Example classes of steviol glycosides are steviolmonoside, steviolbioside, rubososide, steviosides, dulcosides, rebaudiosides. Examples of steviol glycosides are steviolmonoside, steviolmonoside A, steviolbioside, steviolbioside D, rubusoside, steviolbioside A, steviolbioside B, rebaudioside B, stevioside, rebaudioside G, stevioside A, stevioside B, stevioside C, rebaudioside C, rebaudioside A, rebaudioside E, rebaudioside E2, rebaudioside E4, rebaudioside E6, rebaudioside E3, rebaudioside D, rebaudioside I, rebaudioside AM, rebaudioside D7, rebaudioside M, rebaudioside M4, rebaudioside 1a, rebaudioside 1b, rebaudioside 1c, rebaudioside 1d, rebaudioside 1e, rebaudioside 1f, rebaudioside 1g, rebaudioside 1h, rebaudioside 1i, rebaudioside 1j, rebaudioside 1k, rebaudioside 1l, rebaudioside 1m, rebaudioside 1n, rebaudioside 2a, synthetic steviol glycosides, e.g. enzymatically glucosylated steviol glycosides and combinations thereof.

As is known to the skilled person, the sweetness threshold is the highest concentration at which sweet taste cannot be detected. The sweetness threshold can be determined according to the FEMA Guidance Sensory Testing for Flavorings with Modifying Properties (2013, Vol. 67, No. 11).

Preferably, the food or beverage product comprises 40-48 wt % rebaudioside A (reb A), 17-20 wt. % stevioside, and 11-13 wt. % rebaudioside C (reb C) based on the total amount of steviol glycosides in the food or beverage product.

In an embodiment, the present invention provides food or beverage product comprising a steviol glycoside composition, said composition comprising 40-48 wt % rebaudioside A (reb A), 17-20 wt. % stevioside, and 11-13 wt. % rebaudioside C (reb C) based on the total amount of steviol glycosides in the food or beverage product.

The food or beverage product may be any known food or beverage product. For example, the food or beverage product may be alcoholic beverages such as vodka, wine, beer, liquor, and sake, etc.; non-alcoholic beverages; non-carbonated drinks; natural juices; refreshing drinks; carbonated drinks; diet drinks; zero calorie drinks; reduced calorie drinks and foods; yogurt drinks; instant juices; instant coffee; powdered types of instant beverages; canned products; syrups; fermented soybean paste; soy sauce; vinegar; dressings; mayonnaise; ketchups; curry; soup; instant bouillon; powdered soy sauce; powdered vinegar; types of biscuits; rice biscuit; crackers; bread; chocolates; caramel; candy; chewing gum; jelly; pudding; preserved fruits and vegetables; fresh cream; jam; marmalade; flower paste; powdered milk; ice cream; sorbet; vegetables and fruits packed in bottles; canned and boiled beans; meat and foods boiled in sweetened sauce; agricultural vegetable food products; seafood; ham; sausage; fish ham; fish sausage; fish paste; deep fried fish products; dried seafood products; frozen food products; preserved seaweed; preserved meat; tobacco; medicinal products; and many others.

The steviol glycosides in the steviol glycoside composition may be of natural origin or obtained through an enzymatic conversion. Preferably, one or more of the steviol glycosides in the steviol glycoside composition is of natural origin. More preferably, all steviol glycosides in the steviol glycoside composition are of natural origin, as this allows the composition to be labelled as a “natural flavor”.

Preferably, the steviol glycoside composition further comprises rebaudioside B (reb B) and/or rebaudioside F (reb F). More preferably, the steviol glycoside composition further comprises 3.5-5 wt. % rebaudioside B (reb B) and/or 2.5-3.5 wt. % rebaudioside F (reb F) based on the total amount of steviol glycosides in the food or beverage product. It has been found that including these minor steviol glycosides has an improved effect on the flavor modifying properties.

Preferably, the steviol glycoside composition further comprises rebaudioside D (reb D) and/or rebaudioside M (reb M). More preferably, the steviol glycoside composition further comprises 1-2.5 wt. % of rebaudioside D (reb D) and/or 1-2.5 wt % rebaudioside M (reb M) based on the total amount of steviol glycosides in the food or beverage product. It has been found that including these minor steviol glycosides has an improved effect on the flavor modifying properties.

Preferably, the steviol glycoside composition further comprises one or more further steviol glycosides.

More preferably, the steviol glycoside composition comprises 40-48 wt. % reb A, 17-20 wt. % stevioside, 11-13 wt. % reb C, 3.5-5 wt. % reb B, 2.5-3.5 wt. % reb F, 1-2.5 wt. % reb D and 1-2.5 wt. % reb M. The remainder of the steviol glycoside composition may be any one or more steviol glycosides.

Preferably, the steviol glycoside composition is present above about 20 ppm. Below this amount, the flavor modifying or flavor enhancing properties may be reduced.

Preferably, the steviol glycoside composition is present below about 500 ppm. Above this amount, the sweetness of the steviol glycoside composition may be detected, and the flavor modifying or flavor enhancing properties may be reduced.

In an embodiment, the steviol glycoside composition is present in an amount ranging from greater than about 20 ppm to about 500 ppm or an amount ranging from about 30 ppm to about 400 ppm or an amount ranging from about 30 ppm to about 150 ppm or an amount ranging from about 40 ppm to about 300 ppm or an amount ranging from about 50 ppm to about 200 ppm or an amount ranging from about 60 ppm to about 100 ppm or an amount ranging from about 150 ppm to about 250 ppm or an amount ranging from about 150 ppm to about 300 ppm.

In an embodiment, the steviol glycoside composition is present in a beverage in an amount ranging from about 30 ppm to about 150 ppm. In an embodiment, the steviol glycoside composition is present in a cereal composition in an amount ranging from about 150 ppm to about 250 ppm. In an embodiment, the steviol glycoside composition is present in a baked good in an amount ranging from about 150 ppm to about 300 ppm.

Preferably, the food or beverage product is a reduced salt product. Reduced salt products may be healthier, and/or more attractive to the consumer. A reduced salt product is a product which comprises less salt than a representative product of its class. Preferably, the reduced salt product comprises at least 10% less salt, more preferably at least 15% less salt, more preferably at least 20% less salt, more preferably at least 30% less salt, most preferably at least 40% less salt. Salt as used herein refers to sodium chloride.

Preferably, the food or beverage product is a reduced sugar product. Reduced sugar products can be healthier and/or more appealing to consumers. Such products may have a lower calorific value compared to a representative product of its class. A reduced sugar product is a product which comprises less sugar than a representative product of its class. Preferably, the reduced sugar product comprises at least 30% less sugar, more preferably at least 50% less sugar, more preferably at least 90% less sugar, most preferably the reduced sugar product comprises no sugar.

Preferably, the food or beverage product further comprises one or more further additives selected from the group of flavoring agents, flavorings with modifying properties, flavor enhancers, acidulants, natural fruit extracts, natural vegetable extracts, seasonings, herbs, spices, etc. As a person of skill in the art will appreciate, flavoring agents are substances added to impart or help impart a flavor in a food or beverage product. The one or more flavoring with modifying properties and/or the one or more flavor enhancer are preferably present in an amount below their inherent sweetness level. More preferably, the food or beverage product further comprises one or more flavorings with modifying properties in an amount their sweetness level. The addition of further additives may result in a more desirable flavor profile.

The one or more further additive may be any known in the art.

Examples of known flavorings with modifying properties are erythritol; sodium gluconate; rare sugars such as allulose, tagatose, allose, cellobiose; glucosylated glycosides such as mogrosides, sesaminol glycosides, glucosylated steviol glycosides.

Examples of flavoring agents that are known to impart or help impart a sweet flavor include acetone alcohol, adonitol, agave flavor, allyl hexanoate, 4-amino-5,6-dimethyl thieno(2,3-d)pyrimidin-2(1H)-one hydrochloride, 3-((4-amino-2,2-dioxido-1H-2, 1,3-benzothiadiazin-5-yl)oxy)-2,2-dimethyl-N-propyl propanamide, iso-amyl phenyl acetate, star anise seed oil terpeneless, benzyl salicylate, iso-butyl acetoacetate, iso-butyl 2-butenoate, iso-butyl isovalerate, caramel dione, caramel furanone, caramel furanone solution, caramel pentadione, Cocos nucifera fruit juice, beta-cyclodextrin, cyclotene, cyclotene hydrate, 5,5′diacetyl-dithienyl-2,2′-methane, dihydroxyacetone (monomer), 3′,7-dihydroxy-4′-methoxyflavan, 2,5-dimethyl-3-acetyl-pyrrole, ethyl benzoate, ethyl benzoyl acetate, ethyl cyclopentenolone, ethyl furaneol, ethyl 3-hydroxyhexanoate, ethyl 3-(2-hydroxyphenyl) propionate, ethyl lactate, ethyl maltol, ethyl methyl-para-tolyl glycidate, ethylmyristate, ethyl octanoate, ethyl phenyl acetate, ethyl pyrnvate, ethyl salicylate, ethyl isovalerate, ethyl vanillin propylene glycol acetal, eugenol, iso-eugenol, iso-eugenyl phenyl acetate, dextro-fagomine, ferrous lactate, 2-furyl pentyl ketone, genet absolute, geranyl isobutyrate, guaiacyl phenyl acetate, heliotropyl acetone, 2-hexen-1-ol, (Z)-3-hexen-1-yl salicylate, hexyl benzoate, alpha-hexyl cinnamaldehyde, honey enhancer, honey flavor, hydroxycitronellal, hydroxycitronellol, 2-hydroxymethyl pyrazine levodopa, dextro-limonene, lavage tincture, maltitol, maltol, malty! isobutyrate, maltyl propionate, maple distillates, maple furanone, 2-methoxy-4-vinyl phenol, para-methyl acetophenone, methyl anthranilate, 2-methyl butyl acetate, methyl isobutyrate, N-(2-methyl cyclohexyl)-2,3,4,5,6-pentafluorobenzamide, 2-methyl-5,7-dihydrofuro-[3,4-d]-pyrimidine, 5-methyl furfural, 1-(5-methylfuryl)-3-pentanone, methyl heptanoate, methyl salicylate, methyl valerate, 4-methyl-2-(1-methyl-1-butenyl)-1,3-dioxolane, molasses distillates, molasses flavor, beta-naphthyl methyl ketone, Nephelium lappaceum fruit, (E)-2-octenal, octyl propionate, levo-ornithine hydrochloride, phenethyl tiglate, phthalide, pineapple hydroxyhexanoate, sweet potato flavor, praline flavor, prenyl acetate, levo-proline, propenyl guaethol, propyl butyrate, iso-propyl butyrate, propyl isobutyrate, iso-propyl formate, propyl heptanoate, propyl phenyl acetate, iso-propyl phenyl acetate, propyl propionate, propylene glycol, pymvaldehyde, sodium 2-(4-methoxyphenoxy) propionate, strawberry furanone, strawberry furanone acetate, strawberry furanone solution, strawberry glycidate 1, strawberry glycidate 2, sugar distillates, sugar extenders, sugar flavor, brown sugar flavor, burnt sugar flavor, sweet & sour candy flavor, sweet & sour flavor, terpinyl propionate, tetrahydrofurfuryl acetate (E)-tiglic acid, 2,5,7-trimethyl-5,7-dihydrofuro-[3,4-d]-pyrimidine, tyramine, vanilla aromatica fruit extract, vanilla bean absolute (vanilla planifolia), vanilla bean aromatica, vanilla bean planifolia, vanilla concentrate, vanilla oleoresin bali, vanilla oleoresin bourbon, vanilla resinoid, vanilla tahitensis fruit extract, vanillin propylene glycol acetal, para-vanillyl alcohol, vanillyl isobutyrate, 2,6-xylenol, ammonium isovalerate (30% in propylene glycol), aristotelia chilensis fruit juice, aristotelia chilensis leaf extract, benzyl amyl carbinol, benzyl butyl carbinol, benzyl isobutyrate, clary sage absolute, cocoa pentenal, decyl methanesulfinate, ethyl para-anisate, ethyl butyrate, ethyl formate, (E,E)-ethyl sorbate, ethylene brassylate, furfural, furfuryl alcohol, guajillo chile oleoresin, (E)-2-heptenal, hexyl isobutyrate, levulinic acid, lime essence oil, lime pyran, menthyl isovalerate, para-methoxycinnamaldehyde, methyl R-3-acetoxyhexanoate, 3-methyl butyl 2-furyl butyrate, methyl heptadienone, methyl propanesulfinate, (E,E)methyl sorbate, delta-octalactone, phenethyl alcohol, (E)propyl-2-furan acrylate, iso-propyl 2-methyl butyrate, isopropyl octanoate, propylene glycol diacetate, rose oil (rosa damascena) rnssia, rose oil (rosa damascena) turkey, tropical ionone, vanilla carboxylate, veratraldehyde, 3,4-xylenol, acetoin, 2-acetyl-benzothiophene, 2-acetyl-5-methyl thiophene, iso-butyl angelate, iso-butyl formate, bittersweet chocolate flavor, (E)-2-decenoic acid, 2,6-dimethyl naphthalene, ethyl acetate, ethyl decanoate, ethyl 3-(2-furyl) propanoate, 2-ethyl-1-hexanol, ethyl 3-hexenoate, ethyl propionate, ethyl valerate, ethyl vanillin, dextro-fenchone, fuse! oil, 3-heptyl dihydro-5-methyl-2(3H)-furanone, hexyl lactate, alpha-ionol, linalyl isobutyrate, lucuma flavor, massoia bark oil (CO2 extract), alpha-methyl cinnamaldehyde, methyl 3-nonenoate, methyl (E)-3-nonenoate, methyl (E)-2-octenoate, mint lactone, (E,Z)-3,6-nonadien-1-yl acetate, 2-octen-1-ol, (E)-2-octen-1-ol, 2-pentanone, propyl hexanoate, 3-propylidene phthalide, rhodinyl phenyl acetate, shoyu furanone, terpinyl valerate, tolualdehydes (mixed ortho, meta, para), (E,Z,Z)-2,4,7-tridecatrienal, tuberose absolute (from pommade), para-vanillic acid, vanillylidene acetone, anethum graveolens herb tincture, butyl butyrate, cucumber essence, 2-ethyl butyraldehyde, 4-ethyl guaiacol, ethyl 3-oxohexanoate, S-ethyl thioacetate, furfuryl valerate, (E)-2-hexenoic acid, hexyl acetate, 1-(2-hydroxy-4-methoxyphenyl)-3-(pyridin-2-yl)propan-1-one, methional diethyl acetal, alpha-methyl-(E)-cinnamaldehyde, methyl 3-hexenoate, nonanoic acid, octahydrocoumarin, peppermint oil (America), peppermint oil (idaho), perillaldehyde, 4-phenyl-3-buten-2-ol, rose butanoate, 2,2,3-trimethyl cyclopentane ethanol, benzyl acetate, iso-butyl anthranilate, divanillin, (Z)-4-hepten-1-ol, neryl isobutyrate, nonanol, octyl butyrate, iso-valeric acid, vanillin, para-acetanisole, acetophenone, iso-butyl butyrate, butyl isovalerate, ethyl cinnamate, hexyl phenyl acetate, methyl phenyl acetate, ketoisophorone (2,6,6-trimethylcyclohex-2-ene-1,4-dione), (Z)-3-hexenyl methyl ether and vanillyl acetate.

Examples of flavoring agents that are known to impart or help impart a sweet aroma include acetyl longifolene, star anise seed oil terpeneless, caramel dione, caramel furanone, caramel furanone solution, caramel pentadione, coffee dione, cyclotene hydrate, ethyl cyclopentenolone, ethyl furaneol, 4-ethyl-2-hydroxy-3-methyl-2-cyclopenten-1-one, ethyl maltol, ethyl vanillin propylene glycol acetal, evernia prunastri lichen, hexyl 2-methyl-3-pentenoate, homalomena rubescens root oil, honey specialty, 3 (2)-hydroxy-5-methy 1-2(3)-hexanone, 2-hydroxy-3,5,5-trimethyl-2-cyclopenten-1-one, maltol, maltyl isobutyrate, maltyl propionate, maple furanone, melaleuca quinquenervia water, mesitene lactone, 2-methoxy-3,5-dimethyl-2-cyclopenten-1-one, 2-methyl-5, 7-dihydrofuro-[3,4-d]-pyrimidine, (Z)-4-octen-1-ol, 2-pentanoyl furan, 3-pentyl bicyclo[3,2-d]octan-2-one, periploca sepium root oil, (E)-2-phenyl-1(2)-propene-1-yl acetate, phthalide, pineapple hydroxyhexanoate, blackpoplar bud oleoresin, Psidium guajava fruit, rose absolute morocco, rose concrete (rosa damascena), saffron resinoid, sandalwood oil CO2 extract, beta-sinensal, spikenard oil, spikenard oil CO2 extract, strawberry furanone, strawberry furanone acetate, strawberry furanone butyrate, strawberry furanone solution, sugar fragrance, brown sugar fragrance, surfleurs d'oranger oil, sweet pea absolute, sweet pea fragrance, tamarindus indica extract, taraxacum officinale leaf tincture, tilia cordata flower, toffee furanone, tolu balsam oil, 2,5,7-trimethyl-5, 7-dihydrofuro-[3,4-d]-pyrimidine, undecanal propylene glycol acetal, isovaleraldehyde propylene glycol acetal, vanilla aromatica fruit extract, vanilla bean aromatica, vanilla bean planifolia, french vanilla fragrance, vanilla resinoid, vanilla tahitensis fruit extract, vanillin propylene glycol acetal, vanillyl isobutyrate, woodruff absolute, 2-acetyl-3,5-dimethyl furan, isoamyl acetoacetate, amyl hexanoate, isoamyl hexanoate, amyl octanoate, amica flower oil, 2-butoxyethyl acetate, cabreuva wood oil, caraway seed oleoresin, carrot weed oil, citronellyl cinnamate, cyclohexyl crotonate, 2,5-dibutyl-4-methyl oxazole, 1,3-dihydroxyacetone (dimer), epoxyoxophorone, 2-ethyl butyl 2-butenoate, 1-ethyl-2-methyl propyl 3-butenoate, ethyl pentadecanoate, eucalyptus leucoxylon leaf oil algeria, fenchyl acetate, furfuryl ethyl ether, gingergrass oil, green carboxylate, green heptenal, gurjun balsam oil, heliotropyl diethyl acetal, 2-hexyl-5 or 6-keto-1,4-dioxane, alpha-ionol, ivy carbaldehyde/methyl anthranilate Schiffs base, juniper berry concrete, lilac perfume base, Matricaria chamomilla flower oil, (−)-menthone, musk gx (1,3,4,6, 7,8-hexahydro-4,6,6, 7,8,8-hexamethylcyclopenta(g)-2-benzopyran) 50% in benzyl benzoate, musk nonane (1,8-dioxacycloheptadecan-9-one), 2-nonanone, nonyl benzoate, (E,E)-2,6-alloocimene((4E,6E)-2,6-dimethylocta-2,4,6-triene), phenethyl acetate, phenoxyacetic acid, phenyl acetaldehyde, phenyl acetaldehyde 2,3-butylene glycol acetal, phenyl ethylidene acetone, 1-phenyl-2-pentanol, 2-propeny 1-para-cymene, 4-propenyl syringol, propyl butyrate, propyl propanesulfinate, propyl isovalerate, 3-propylidene phthalide, isopulegyl acetate, isosafrole, strawberry furanone methyl ether, 1,3,4-trimethyl pentyl 2-butenoate, 1,2,2-trimethyl propyl 2-butenoate, tropical indene, tuberose absolute (from concrete), tuberose absolute (from pommade), turmeric root oil china, vanilla bean oil (vanilla planifolia), vanilla planifolia fruit infusion, annuswormwood oil france, acetaldehyde benzyl 2-methoxyethyl acetal, acetaldehyde hexyl isoamyl acetal, acetyl tributyl citrate, agarwood oil (aetoxylon sympetalum), isoamyl butyrate, angelica seed oil, benzaldehyde propylene glycol acetal, brachyleana hutchinsii wood oil, isobutyl anthranilate, isobutyl propionate, alpha-campholenic alcohol, chamomile oil morocco, (E)-cinnamic acid, citral, cocoa essence, (R)-delta-decalactone, 9-decen-5-olide-2,4-diethyl-5-propyl oxazole, 2,5-diethyl tetrahydrofuran, 3′,4′-dimethoxyacetophenone, (R)-delta-dodecalactone, elder flower absolute (sambucus canadensis and s. nigra), endo-ethyl bicyclo(2.2.1)-5-heptene-2-carboxylate, ethyl butyryl lactate, (S)-2-ethyl hexanoic acid, ethyl 5-hydroxydecanoate, ethyl methyl anthranilate, 10-epi-gammaeudesmol, isoeugenyl formate, eugenyl phenyl acetate, (E)beta-famesene, white frangipani concrete, freesia acetate, gardenia absolute, grains of paradise oil, 2-heptanol, 3-heptanone, 4-heptanone, hexanal butane-2,3-diol acetal, (Z)-3-hexen-1-yl acetate, (Z)-3-hexen-1-yl lactate, sec-hexyl alcohol, 4-hydroxyphenethyl alcohol, 3-hydroxy-4-phenyl-2-butanone, cis-2-hydroxy-3,4,5-trimethyl-2-cyclopenten-1-one, trans-2-hydroxy-3,4,5-trimethyl-2-cyclopenten-1-one, beta-ionone, kewda oil, lavender oil, lime oil expressed florida, (3S,6S)-(Z)-linalool oxide (pyranoid), marigold oil mexico, massoia bark oil CO2 extract, menthyl isovalerate, 3-mercapto-3-methyl butanol, 3-mercapto-3-methyl-1-butyl acetate, methionol, para-methoxycinnamaldehyde, (E)-paramethoxycinnamaldehyde, methyl 2-hydroxy-4-methyl valerate, 2-methyl naphthalene, methyl octanoate, methyl sandal, 5-methyl tetrahydrofuran-3-one, musk cyclopentenyl propionate ([2,2-dimethyl-3-(2-methyl-5-prop-1-en-2-yl-1-cyclopentenyl)propyl]propanoate), musk decanolide (1,6-dioxacycloheptadecan-7-one), musk gx (1,3,4,6,7,8-hexahydro-4,6,6,7,8,8-hexamethylcyclopenta(g)-2-benzopyran) 100%, narcissus flower absolute, gamma-nonalactone, nonyl anthranilate, isooctyl acetate, octyl oxyacetaldehyde, opoponax resinoid replacer, peach pivalate, pear valerate, petitgrain combava oil, sesquiphellandrene, phenethyl lactate, phenethyl phenyl acetate, phenethyl tiglate, 4-phenyl-2-butyl acetate, isophorone, ketoisophorone, pineapple pentenoate, 2-isopropoxy-3(5)-methyl pyrazine, propyl mercaptan, 2-isopropyl-4-methyl-3-thiazoline, isopropylpropionate, propyl pyruvate, propylene glycol dibutyrate, rhododendron anthopogon leaf oil, rose leaf absolute (rosa centifolia), styryl acetate, tea leaf absolute, (R)-tonka furanone, (R)-N,N,alpha-trimethyl benzyl amine, 2,6,6-trimethyl-2-hydroxycyclohexanone, tuberose acetate, (R)-deltaundecalactone, (R)-gamma-undecalactone, (S)-deltaundecalactone, (S)-gamma-undecalactone, valerian rhizome absolute, vanilla bean absolute (vanilla planifolia), vanilla tahitensis fruit absolute, vanilla tahitensis fruit absolute CO2 extract, vanilla tahitensis fruit oil CO2 extract, para-vanillic acid, vanillin hexylene glycol acetal, dextro-xylose, ylang ylang flower absolute, acetyl ethyl tetramethyl tetralin replacer, 9-acetyl-5-methyl-tricyclo[6.2.1.0.sup.2,7]undec-4-ene, allyl isononylate, isoamyl decanoate, amyl propionate, amyl salicylate, homoanisaldehyde, laevo-bomeol, isobornyl acetate, isobornyl phenyl acetate, isobutyl formate, 2-butyl furan, 1-isobutyl-2-methyl butyl 2-butenoate, alpha-campholene acetate, capsicum oleoresin, carvyl propionate, (Z)-civet decenone, 2,6-dimethyl-3-oxatricyclo(4.2.1.0*2,4*)nonane, 1,3-dithiolane, elecampane root absolute, delta-elemene, alpha-ethoxy-ortho-cresol, ethyl (Z)-4-heptenoate, ethyl 3-mercaptobutyrate, 1-ethyl-2-methyl propyl 2-butenoate, ferula assa-foetida absolute, filbert heptenone, furfuryl alcohol, ginger root absolute; ginseng, grapefruit oil folded florida, isogreen methanoindene, guaiacwood oil 20% in gurjun balsam oil, (S)-gamma-heptalactone, 3-heptyl acetate, (S)-gamma-hexalactone, (E)-2-hexenoic acid, 3-hexenyl 2-methyl butyrate, hexoxyacetaldehyde dimethyl acetal, hexyl formate, hexyl 2-furoate, hinoki root oil, hop oil, hydroxymethyl hexyl ethyl ketone, juniper muscone, laurel bark oil, laurel stem oil, lawsonia inermis flower absolute, levisticum officinale herb oil, (Z)-linalool oxide (furanoid), litsea cubeba oil terpenes, melissa oil (slovak republic), laevo-menthyl isobutyrate, methyl benzyl acetate (mixed ortho-,meta-,para-), 2-methyl butyl propionate, alpha-methyl-(E)-cinnamaldehyde, 6-methyl heptanal, methyl ionone terpenes, methyl 4-methyl benzoate, methyl 4-phenyl butyrate, musk ambrette replacer, musk gx 50% in diethyl phthalate, musk gx 50% in DPG, myrtenol, nirvanolide, (E)-2-nonen-1-yl acetate, 2-nonyn-1-al dimethyl acetal, cis-oak lactone, 3-octanone, origanum majorana oil CO2 extract, perillaldehyde, 2-phenoxyethyl formate, 4-phenyl-2-butanol, phenyl glycol phenyl acetate, 3-phenyl propyl cinnamate, phenyl salicylate, isopropenyl acetate, (R)-(+)-pulegone, reseda acetal, rose absolute (rosa damascena) bulgaria, rose undecene, sandal glycol acetal, satinaldehyde, sodium ferulate, styralyl alcohol, syringaldehyde, tea acetate, tetrahydrofurfuryl phenyl acetate, ortho-thioguaiacol, 3 (or 2), 4,5-trimethyl octahydro-4,7-methanoinden-5-yl acetate, 4,6,11-trimethyl-5-oxatricyclo(6.2.2.0*4,9*)dodec-6-ene, vanilla bean absolute, vanilla oleoresin bourbon, 4-vinyl phenol and wine lactone, aeolanthus graveolens oil, amber naphthofuran, para-anisaldehyde/methyl anthranilate Schiff s base, betabisabolol, capsicum oleoresin CO2 extract, cuminyl acetate, (E)-beta-damascenone, (R)-gamma-decalactone, (S)-deltadecalactone, 2,5-dimethyl bicyclo(3.2.1)-2-octen-3-yl acetate+1,4-dimethyl bicyclo(3.2.1)-2-octen-3-yl acetate, (R)-gamma-dodecalactone, 2-ethyl-1-hexanol, (R)-gammaheptalactone, hexanol, (Z)-3-hexen-1-yl phenyl acetate, hexyl acetate, labdanum absolute, para-methyl benzyl acetate, methyl heptadienone, nonanal/methyl anthranilate Schiffs base, ocimenol, Passiflora edulis fruit extract, phenyl acetaldehyde/methyl anthranilate Schiffs base, robinia pseudoacacia absolute, sea resorcylate, delta-tetradecalactone, verbena absolute france, vetiveryl acetate, ylang ylang flower oil I, ylang ylang flower oil, zedoary bark oil, agrumen nitrile, artemisia vestita wall leaf oil, benzyl acetate, benzyl salicylate, butyl 2-naphthyl ether, khella oil, leafy acetal, (R)-ocean propanal, (S)-ocean propanal, octahydro-4,7-methano-1H-indene-5-acetaldehyde+6-methyloctahydro-4,7-methano-indene-5-carbaldehyde, spearmint oil America, strawberry glycidate 1, vanilla oleoresin bali, veratraldehyde, (Z)-3-hexenyl methyl ether, methyl paraanisate, vanillin, vanillyl acetate. 4-(3,3-dimethyl bicyclo(2.2.1)hept-2-yl)-1-methyl-2-oxabicyclo(2.2.2)octane, 2-phenyl-2-pentenal, and (E)-2,5,9-trimethyl-4,9-decadien-1-al. In an embodiment, cocoa flavor is reminiscent of the aroma and flavor of cocoa powder and chocolate (including dark chocolate, semi-sweet chocolate and milk chocolate).

Examples of flavoring agents that are known to impart or help impart a sugary flavor include caramel color, sugar cookie flavor, ethyl maltol, malt distillates, marzipan flavor, orris rhizome absolute (iris germanica), orris rhizome absolute (iris pallida sugar cane distillate, brown sugar cinnamon flavor, burnt sugar flavor, maple brown sugar flavor sweet flavor, sweetness enhancers, caramel dione, caramel furanone solution, cinnamon sugar cookie flavor, ethyl furaneol, methyl 2-furoate, praline flavor, pyruvic acid, vanilla sugar, caramel furanone, caramel pentadione, crème brûlée flavor, crème brûlée coffee flavor and strawberry furanone.

Examples of flavoring agents that are known to impart or help impart a sugary aroma include caramel color, cotton candy fragrance, marzipan fragrance, sugar cookie fragrance, sugar fragrance, brown sugar fragrance, caramel dione, diethyl malate, malt distillates, malty! isobutyrate, mesitene lactone, caramel furanone, caramel furanone solution, caramel pentadione, coffee dione, creme brulee fragrance, cyclotene hydrate, ethyl furaneol, 1-ethyl-2-methyl propyl 2-butenoate, barley malt extract, menthone lactone, 2-mercaptomethyl pyrazine, methyl bicycloheptenyl methyloxirane carboxylate, strawberry furanone solution, shoyu furanone, spicy pentanone, strawberry furanone, strawberry furanone acetate, toffee furanone, ethyl cyclopentenolone, ethyl maltol, Hordeum vulgare extract (cereal grass), betadamascenone and 3-phenyl propyl isobutyrate.

Examples of flavoring agents that are known to impart or help impart a caramelized flavor include 2-butyl-3,6-dimethyl pyrazine, 2-butyl-3,5,6-trimethylpyrazine, caramel cappuccino flavor, caramel apple flavor, caramel candy flavor, caramel cashew flavor, caramel cocoa flavor, caramel coconut flavor, caramel coffee flavor, caramel corn flavor, caramel cream flavor, caramel custard flavor, caramel flavor, burnt caramel flavor, caramel fudge flavor, caramel furanone, caramel latte flavor, caramel macchiato flavor, caramel malted mambo flavor, caramel mocha flavor, caramel nut cream flavor, caramel nut flavor, caramel nut fudge flavor, caramel peanut flavor, caramel pecan flavor, caramel toffee flavor, caramel walnut shortbread flavor, coffee dione, crème brulee flavor, cyclotene hydrate, 2-dimethyl-3-butyl pyrazine, ethyl furaneol, 3-ethyl pyridine, fenugreek distillates, roasted fenugreek flavor, fenugreek resinoid, fenugreek seed oil, 3,4-hexane dione, 2-hydroxy-2-cyclohexenone, barley malt extract, maple flavor 2-(methoxymethyl) pyridine, 3-methyl butyl 2-furyl butyrate, methyl 2-furoate, 6-methylpyridine-2-aldehyde, 1-phenyl-1,2-propane dione, 5-propylthiophene-2-aldehyde, 2-pyridine carboxaldehyde, pyruvaldehyde, dextro-sorbitol, strawberry furanone, strawberry furanone acetate, strawberry furanone solution, toffee flavor, English toffee flavor, trigonella foenum-graecum essence, trigonella foenum-graecum extract, trigonella foenum-graecum tincture, acetyl propionyl, bananas foster flavor, butter caramel flavor, butyl levo-lactate, iso-butyl lactate, cajeta flavor, caramel pentadione, chocolate caramel flavor, chocolate caramel flavor, white chocolate caramel flavor, chocolate caramel nut flavor, 3,5-cocoa pyrazine, coffee caramel flavor, creme brulee coffee flavor, creme caramel flavor, cyclohexyl acetic acid, 2,5-dimethyl-3,6-diisobutyl pyrazine, eggnog creme brulee flavor, 3-ethyl-1,2-cyclopentadione, 5-ethyl-3,4,5,6-tetramethyl cyclohexen-2-one, ethyl vanillin, flan flavor, 2-furoic acid, Helichrysum italicum flower absolute, honey distillates, lucuma flavor, 2,3-lutidine, maltyl propionate, molasses flavor, caramelized onion flavor, orange caramel flavor, peanut brittle flavor, pecan caramel flavor, 4-phenyl pyridine, caramel popcorn flavor, 2-propanoyl thiophene, 2-iso-propyl pyrazine, shoyu furanone, tetrahydrofurfuryl acetate, 5-thenyl-thiophene-2-aldehyde, vanilla caramel flavor, 2-vinyl benzofuran, (E)-aconitic acid, almond toffee crunch flavor, almond toffee flavor, butter maple flavor, butter praline flavor, butter toffee flavor, 2-oxo-butyric acid, coffee creme brulee flavor, coffee distillates, cyclotene, fenugreek absolute, chocolate fudge caramel flavor, furfuryl alcohol, 2-(2-furyl)ethanethiol, honey maple flavor, maple cream flavor, maple nut flavor, maple pecan flavor, toasted marshmallow flavor, 2-(1-mercaptoethyl) furan, 5-methyl furfural, caramelized onion oleoresin, praline flavor, toasted praline flavor, vanilla oleoresin bali, aconitic acid, caramel dione, ethyl crotonate, ethyl (E)-2-crotonate, malt distillates, malty! isobutyrate, maple furanone, toasted maple nut flavor, rum ether, spicy acetoacetate, acetyl butyryl, ethyl lactate, 2,3-heptane dione, 2-pentyl furan, diacetyl trimer, furfural, furfuryl valerate and 2-methyl butyraldehyde. In an embodiment, caramelized flavor is reminiscent of the odor and flavor produced when caramelizing sugar without burning it.

Examples of flavoring agents that are known to impart or help impart a caramelized aroma include 4-acetyl-2,5-dimethyl-3(2H)-furanone, 6-acetyl-1,2,3,4-tetrahydropyridine, allyl 2-furoate, amyl 2-furoate, isoamyl pyruvate, butterscotch fragrance, 2-oxobutyric acid, caramel corn fragrance, caramel dione, caramel fragrance, caramel furanone, caramel furanone solution, coffee dione, cyclotene, cyclotene hydrate, diethyl malate, alpha,alpha-dimethyl anisyl acetone, 3-ethyl-1,2-cyclopentadione, ethyl cyclopentenolone, ethyl furaneol, ethyl 4-hydroxybutyrate, ethyl 2-hydroxy-2-methyl butyrate, ethyl-4-hydroxymethyl-3-(2H)-furanone, ethyl levulinate propylene glycol ketal, ethyl maltol, 5-ethyl-2,3,4,5-tetramethyl-2-cyclohexen-1-one, 5-ethyl 1-3,4, 5, 6-tetramethyl I cyclohexen-2-one, fenugreek absolute, fenugreek concrete, fenugreek seed oil, geranyl crotonate, helichrysum italicum flower absolute, helichrysum italicum flower extract, Hordeum vulgare cera, hydroxy dimethyl cyclopentenone, 2-hydroxy-3,5,5-trimethyl-2-cyclopenten-1-one, immortelle absolute, levulinic acid, barleymalt extract, malt fragrance, maltol, maltyl isobutyrate, maltyl propionate, maple fragrance, maple furanone, menthone lactone, mesitene lactone, 2-methoxy-3,5-dimethyl-2-cyclopenten-1-one, 5-methyl furfural, methyl levulinate, 2-pentanoyl furan, isopropenyl pyrazine, propyl levulinate, propyl pyruvate, rosa canina seed extract, rose furan, shoyu furanone, dextro-sorbitol, (S)-strawberry furanone, strawberry furanone acetate, strawberry furanone ethyl ether, (R)-strawberry furanone methyl ether, strawberry furanone solution, toffee furanone, trigonella foenumgraecum essence, trigonella foenum-graecum extract, trigonella foenum-graecum tincture, acetone alcohol, acetyl butyryl, 2-acetyl-3,4,5,6-tetrahydropyridine, isoamyl levulinate, caramel pentadione, creme brulee fragrance, cyclotene propionate, diethyl 2-hydroxyglutarate, 2,5-diethyl tetrahydrofuran, 3-ethyl-4-methyl cyclotene, 5-ethyl-3-methyl cyclotene, ethyl vanillin, furfuryl acetone, furfuryl decanoate, Hordeum vulgare extract (cereal grass), 2-hydroxy-2-cyclopenten-1-one, 3-hydroxy-3-penten-2-one, cis-2-hydroxy-3,4,5-trimethyl-2-cyclopenten-1-one, isomaltol, mango furanone, 2-mercaptomethyl pyrazine, nutty cyclohexenone, 4-pentenoic acid, 2-propanoyl thiophene, pyruvaldehyde, pyruvic acid, strawberry furanone, 2-thiophene thiol, tonka bean absolute replacer, tonka bean resinoid, vanilla bean absolute (vanilla planifolia), vanilla oleoresin bourbon, amerinal, isobutyl lactate, 3,5-cocoa pyrazine, coffee distillates, 1,2-cyclohexane dione, diacetyl, ethyl (E)-2-crotonate, fenugreek oleoresin, furfural, 2-furyl acetone, geranyl ethyl acetal, 3-mercapto-3-methyl butyl formate, 2-methoxythiazole, 3-methyl butyl 2-furyl butyrate, methyl 2-hydroxy-3-methyl pentanoate, methyl nonane dione, (E)propyl-2-furan acrylate, strawberry furanone methyl ether, 2,3,5,6-tetramethyl pyrazine, (E)-tiglic acid, tonka bean absolute, (E,E)-2,4-undecadienal, 2-acetyl-3,6-dimethyl pyrazine, 2-acetyl-3,S (or 6)-dimethyl pyrazine, 2-acetyl furan, acetyl propionyl, (R)-gamma-decalactone, ethyl lactate, 3,4-hexane dione, opoponax resin (commiphora erythraea var. glabrescens engler), phenethyl octanoate, tetrahydrofurfuryl acetate, tetrahydrofurfuryl alcohol, vanillyl isobutyrate, dextro-xylose, (E)-aconitic acid, benzyl disulfide, butyl levulinate, 2,3-dimethyl pyrazine, ethyl 4-pentenoate, ethyl pyruvate, ethyl vanillin isobutyrate, furfuryl alcohol, furfuryl octanoate, gamma-heptalactone, 5-hydroxymethyl furfural, malt distillates, 2-methyl furan, opoponax oil (commiphora erythraea var. glabrescens engle), peanut oxazole, vanilla oleoresin bali, aconitic acid, (E)ethyl tiglate, 2-methyl thio-3,5 or 6-methyl pyrazine, opoponax absolute (commiphora erythraea var. glabrescens engle), 2-pentyl furan, isoamyl 3-(2-furan) propionate, chocolate pyrazine A, cyclohexyl acetic acid, nutty quinoxaline, 2-acetyl-5-methyl furan, isobutyl 2-butenoate, 4-methyl-2,6-dimethoxyphenol, (E,E)-pomarose and trigonella foenum-graecum seed oil CO2 extract.

Examples of flavoring agents that are known to impart or help impart a maple flavor include caramel pentadione, cyclotene, 2,5-dimethyl-3,6-diisobutyl pyrazine, 3-ethyl-1,2-cyclopentadione, fenugreek absolute, lucuma flavor, maple butter flavor, maple cream flavor, maple distillates, maple flavor, maple nut crunch flavor, maple nut flavor, toasted maple nut flavor, maple pecan cream flavor, maple pecan flavor, maple syrup, maple walnut flavor, butter maple flavor, caramel furanone, cyclotene hydrate, gac fruit distillates, honey maple flavor, maple pumpkin flavor, maple brown sugar flavor, acer spicatum bark extract, caramel dione, red cinchona bark, cyclohexyl acetic acid; fenugreek oleoresin, maple furanone, levisticum officinale root extract; lavage tincture, 5-methyl furfural and ethyl cyclopentenolone.

Examples of flavoring agents that are known to impart or help impart a maple aroma include caramel pentadione, 3-ethyl-4-methyl cyclotene, fenugreek oleoresin, 2-hydroxy-2-cyclopenten-1-one, cis-2-hydroxy-3,4,5-trimethyl-2-cyclopenten-1-one, maple fragrance, acer spicatum bark extract, caramel furanone, caramel furanone solution, red cinchona bark, 1,2-cyclohexane dione, cyclotene, cyclotene hydrate, ethyl cyclopentenolone, trans-2-ethylidene-trans-3-hexenal, fenugreek absolute, geranyl crotonate, menthone lactone, 2-methoxy-3,5-dimethyl-2-cyclopenten-1-one, caramel dione, fenugreek resinoid, maple furanone, shoyu furanone, 2-hydroxy-3,4,5-trimethyl-2-cyclopenten-1-one, 5-methyl furfural, 3-propylidene phthalide, molasses blackstrap, strawberry furanone methyl ether, whiskey lactone and cyclohexyl acetic acid.

Examples of flavoring agents that are known to impart or help impart a cotton candy flavor include cotton candy flavor, maltol, ethyl maltol, strawberry furanone solution, caramel furanone, maltyl isobutyrate and raspberry ketone.

Examples of flavoring agents that are known to impart or help impart a cotton candy aroma include cotton candy fragrance, diethyl 2-hydroxyglutarate, strawberry furanone, ethyl maltol, maltol, strawberry furanone solution, toffee furanone, caramel furanone, heliotropyl acetone and maltyl isobutyrate.

Examples of flavor enhancers are abrusoside A, alitame, aspartame, baiyunoside, brazzein, curculin, cyclocarioside I, glycyphyllin, glycyrrhizic acid, hemandulcin, N-[N-[3-(3-hydroxy-4-methoxyphenyl) propyl]-L-[alpha]-aspartyl]-L-phenylalanine I-methyl ester, N-[N-[3-(3-hydroxy-4-methoxyphenyl)-3-methylbutyl]-L-[alpha]-aspartyl]-L-phenylalanine 1-methyl ester, a Luo Han Guo extract, mabinlin, N-[N-[3-(3-methoxy-4-hydroxyphenyl)propyl]-L-[alpha]-aspartyl]-L-phenylalanine 1-methyl ester, monatin, monellin, mukurozioside, neohesperidin dihydrochalcone, neotame, osladin, periandrins, phlomisosides, phloridzin, phyllodulcin, polypodoside A, pterocaryoside A, pterocaryoside B, thaumatin and trilobatin, and salts and/or solvates thereof.

The present invention further provides a method of preparing a food or beverage product comprising including in said food or beverage product a steviol glycoside composition comprising rebaudioside A (reb A), stevioside, and rebaudioside C (reb C), wherein the steviol glycoside composition is present in an amount below its sweetness threshold. The method is suitable to make the food or beverage product of the invention.

The including in said food or beverage product the steviol glycoside composition can be done by adding the steviol glycoside composition during the production of the food or beverage product. For example, a flavoring composition comprising the steviol glycoside composition and one or more flavoring agents could be added during the production of the food or beverage product. Alternatively, the steviol glycoside composition may be added to the “finished” product, for example, by blending the steviol glycoside composition with the product. In the case of beverage products which require dilution prior to consumption by a consumer (e.g. beverage concentrates (including, but not limited to, liquid concentrates and syrups as well as non-liquid ‘concentrates’, such as freeze-dried and/or powder preparations)), or in the case of pre-made mixes which require reconstitution and possibly further processing to produce the final food or beverage product (e.g. pre-made sweet bakery mixes for preparing sweet bakery products or pre-made bread mixes for preparing bread products) the steviol glycoside composition will be in an amount below its sweetness threshold in the finished food or beverage product (e.g. the final made-up beverage product or baked food product).

Preferably, the steviol glycoside composition further comprises rebaudioside B (reb B) and/or rebaudioside F (reb F). More preferably, the steviol glycoside composition further comprises 3.5-5 wt. % rebaudioside B (reb B) and/or 2.5-3.5 wt. % rebaudioside F (reb F) based on the total amount of steviol glycosides in the food or beverage product. It has been found that including these minor steviol glycosides has an improved effect on the flavor modifying properties.

Preferably, the steviol glycoside composition further comprises rebaudioside D (reb D) and/or rebaudioside M (reb M). More preferably, the steviol glycoside composition further comprises 1-2.5 wt. % of rebaudioside D (reb D) and/or 1-2.5 wt % rebaudioside M (reb M) based on the total amount of steviol glycosides in the food or beverage product. It has been found that including these minor steviol glycosides has an improved effect on the flavor modifying properties.

Preferably, the method further comprises adding one or more further additives selected from the group of flavors, flavorings with modifying properties, flavor enhancers, acidulants, natural fruit extracts, natural vegetable extracts, seasonings, herbs, spices, etc. The one or more flavoring with modifying properties and/or the one or more flavor enhancer are preferably used in an amount below their sweetness level. More preferably, the method further comprises adding one or more flavorings with modifying properties in an amount below their sweetness level. The addition of further additives may result in a more desirable flavor profile.

The one or more further additive may be any known in the art.

Examples of known flavorings with modifying properties are erythritol; sodium gluconate; rare sugars such as allulose, tagatose, allose, cellobiose; glucosylated glycosides such as mogrosides, sesaminol glycosides, glucosylated steviol glycosides.

Preferably, flavor and/or taste of the food or beverage product is modified or enhanced. “Modifying” of flavor means that certain attributes of the food or beverage product flavor profile are changed. Such attributes can be for example sweetness, saltiness, bitterness, juiciness, zestiness, smokiness etc., but also specific flavors such as brown paper flavor, lemon flavor, etc. “Enhancing” of flavor means that at least certain attributes are enhanced.

Incorporating the steviol glycoside composition at an amount below its sweetness threshold in food or beverage products may modify or enhance a flavor of said food or beverage products by altering flavor attributes such as intensifying specific flavor characteristics, reducing specific flavor characteristics, masking of off-notes or bitterness, or changing the time onset and duration of the perception of specific aspects of the flavor. For example, the steviol glycoside composition may modify or enhance a flavor of said food and beverage products by altering the perception of flavor by the consumer. The steviol glycoside composition may alter the perception of a flavor by altering the quality or intensity of the flavor, for example by enhancing, strengthening, softening, or sharpening the flavor. The steviol glycoside composition may also modify any aspect of the temporal profile of the flavor of the food or beverage product.

Flavor is associated with the taste and aroma of a food or beverage product. Taste is a sensation that is produced when a substance interacts with a taste receptor in the oral cavity. The five established taste dimensions are: sweet, salty, bitter, sour, and umami. Flavor, however, is an integrated sensory experience determined primarily by a combination of taste and smell, but which may also be influenced by other sensory components such as mouthfeel.

In view of the fact that flavor is an integrated sensory experience, it is possible for one sensory component, particularly aroma, to evoke a particular flavor even in the absence of other sensory components. For example, the aroma of a sweet food such as cotton candy will evoke a sweet flavor, even in the absence of a sweet taste. As such, flavoring agents used to provide such flavors in food or beverage products are often described as “sweet flavors”, even though the flavoring agents themselves will often not have a sweet taste.

The modification or enhancement of flavor and/or taste can be determined according to the FEMA Guidance Sensory Testing for Flavorings with Modifying Properties (2013, Vol. 67, No. 11). The control should be the same product without the steviol glycoside composition.

Preferably, the off-flavor is reduced in the method of the invention. Off-flavor can be any flavors that are undesirable, for example bitterness or licorice-like aromas, metallic flavor, astringent mouthfeel. These off-flavors are commonly associated with sweeteners. The reduction is relative to a control food or beverage product not comprising the steviol glycoside composition.

Preferably, salt flavor and/or taste is enhanced in the method of the invention. Enhancing of salt flavor allows to prepare food or beverage products having a lower salt content but the same saltiness level. Reduced salt products may be healthier, and/or more attractive to the consumer.

Preferably, sweet flavor and/or taste is enhanced in the method of the invention. Enhancing of sweet flavor allows to prepare food or beverage products having a lower sugar content but the same sweetness level. Reduced sugar products may be healthier, and/or more attractive to the consumer. The enhancement is relative to a control food or beverage product not comprising the steviol glycoside composition.

Preferably, the sweet flavor is a sweet aromatic flavor, more preferably a sweet aromatic flavor perceived primarily or exclusively by retronasal smell. More preferably, the sweet aromatic flavor is selected from the group consisting of caramelized flavor, maple flavor, sugary flavor, cocoa flavor, tropical flavor, and cotton candy flavor. In an embodiment, tropical flavor refers to a flavor reminiscent of any fruit produced by a tree native to the tropics (e.g. fruity flavors such as passion fruit, coconut, pineapple and mango; citrus options such as orange and mandarin and other tropical fruit flavors).

Preferably flavor and/or taste is enhanced in the method of the invention. Enhanced flavor allows to use less flavorings, thus reducing costs. More preferably, said flavor and/or taste is total flavor, smoke flavor, pepper flavor, heat/burn, sour taste, citrus flavor, bitter taste, or umami flavor, wherein the umami flavor is preferably selected from the group consisting of tomato flavor, onion/garlic flavor, dairy flavor, nutty flavor, oat flavor. The enhancement is relative to a control food or beverage product not comprising the steviol glycoside composition.

The present invention provides the use of a steviol glycoside composition comprising rebaudioside A (reb A), stevioside, and rebaudioside C (reb C) as a flavor modifying or flavor enhancing agent. The modification or enhancement of flavor and/or taste can be determined according to the FEMA Guidance Sensory Testing for Flavorings with Modifying Properties (2013, Vol. 67, No. 11).

Preferably, the steviol glycoside composition comprises 40-48 wt % rebaudioside A (reb A), 17-20 wt. % stevioside, and 11-13 wt. % rebaudioside C (reb C).

Preferably, the steviol glycoside composition comprises rebaudioside B (reb B) and/or rebaudioside F (reb F). More preferably, the steviol glycoside composition comprises 3.5-5 wt. % rebaudioside B (reb B) and/or 2.5-3.5 wt. % rebaudioside F (reb F).

Preferably, the steviol glycoside composition comprises rebaudioside D (reb D) and/or rebaudioside M (reb M). More preferably, the steviol glycoside composition comprises 1-2.5 wt. % of rebaudioside D (reb D) and/or 1-2.5 wt % rebaudioside M (reb M).

Preferably, off-flavor is reduced. The reduction is relative to a control wherein the steviol glycoside composition is not used.

Preferably, salt flavor is enhanced. The enhancement is relative to a control wherein the steviol glycoside composition is not used.

Preferably, sweet flavor is enhanced. More preferably, the sweet flavor is a sweet aromatic flavor. The sweet aromatic flavor preferably selected from the group consisting of caramellic flavor, maple flavor, sugary flavor, and cotton candy flavor. The enhancement is relative to a control wherein the steviol glycoside composition is not used.

Preferably, flavor and/or taste is enhanced. More preferably, said flavor and/or taste is total flavor, smoke flavor, pepper flavor, heat/burn, sour taste, citrus flavor, bitter taste, or umami flavor, wherein said umami flavor is preferably selected from the group consisting of tomato flavor, onion/garlic flavor, dairy flavor, nutty flavor, oat flavor. The enhancement is relative to a control wherein the steviol glycoside composition is not used.

Preferably, the steviol glycoside composition is used in combination with an additive selected from the group of flavoring agents, flavorings with modifying properties, flavor enhancers, acidulants, natural fruit extracts, natural vegetable extracts, seasonings, herbs, spices, etc. The one or more flavoring with modifying properties and/or the one or more flavor enhancer are preferably used in an amount below their sweetness level. More preferably, the method further comprises adding one or more flavorings with modifying properties in an amount below their sweetness level. The addition of further additives may result in a more desirable flavor profile.

The one or more further additive may be any known in the art.

Examples of known flavorings with modifying properties are erythritol; sodium gluconate; rare sugars such as allulose, tagatose, allose, cellobiose; glucosylated glycosides such as mogrosides, sesaminol glycosides, glucosylated steviol glycosides.

### EXAMPLES

A steviol glycoside composition (“SG composition”) was prepared according to Table 1:

| Steviol glycoside | Amount/wt. % |
|---|---|
| rebaudioside A | 44.8 |
| Stevioside | 17.4 |
| rebaudioside C | 11.0 |
| rebaudioside B | 4.4 |
| rebaudioside F | 2.6 |
| rebaudioside G | 1.3 |
| rebaudioside D | 1.2 |
| Steviolbioside | 1.1 |
| rebaudioside M | 1.1 |
| Other steviol glycosides each present | 15 wt. % |
| in an amount lower than 1 wt. % | |

The prepared composition was used in the following examples.

### Example 1: Determination of the Sweetness Threshold

The sweetness threshold was determined according to the FEMA Sensory guidance document Guidance for the Sensory Testing of Flavorings with Modifying Properties, within the FEMA GRAS™ Program, 2013—the recognition threshold concentration was determined using 2-alternate forced choice (2-AFC) methodology. The control was a 1.5% w/w sucrose solution in water.

The test was performed by highly trained panelists with 112 observations over 3 sessions. The samples were balanced, randomized within and between pairs, and blind coded.

A 40 ppm solution of the composition in water was found to be significantly less sweet (95% confidence interval) than the control solution.

### Example 2: Flavor Modifying Properties

Eight products were prepared, to which a small amount of the steviol glycoside composition was added. Several concentrations of the steviol glycoside composition below the sweetness recognition threshold for various applications were prepared and compared to their respective negative controls (without added steviol glycoside composition).

Descriptive sensory analysis was performed by highly trained panelists with 30 to 70 observations per product type. The samples were balanced, randomized within and between pairs, and blind coded.

TABLE 2
Sensory Analysis Results.

| | Amount of | | |
|---|---|---|---|
| | steviol glycoside | | |
| | composition in | Significantly increased | Significantly reduced |
| Product type | product (w/w) | flavors (95% CI) | flavors (95% CI) |
| 50% Reduced | 40 ppm | Sweet taste, salt taste, | Onion flavor, garlic |
| Sugar BBQ | | smoke flavor, tomato | flavor |
| Sauce (with | | flavor, heat/burn, | |
| reb M) | | caramelized flavor | |
| 50% Reduced | 40 ppm | Sweet taste, salt taste, | Peanut flavor |
| Sugar BBQ | | smoke flavor, tomato | |
| Peanuts (with | | flavor, onion flavor, | |
| reb A) | | garlic flavor, black | |
| | | pepper flavor, heat/burn | |
| Southwestern | 40 ppm | Sweet taste, salt taste, | Total flavor, onion flavor, |
| Ranch Salad | | sour taste, buttermilk | garlic flavor, red/chilli |
| Dressing | | flavor | pepper, brown spice, |
| | | | paprika |
| Sweetened | 40 ppm | Sweet taste, bitter taste, | Sweet aromatics |
| Black Tea | | dried leaves flavor, citrus | |
| (with stevia) | | flavor, solvent flavor, | |
| | | brown paper flavor | |
| Chocolate | 40 ppm | Sweet taste, total flavor, | |
| Almond Milk | | chocolate flavor, | |
| | | caramelized flavor, nutty | |
| | | flavor | |
| Chocolate | 100 ppm | Sweet taste, total flavor, | Brown paper flavor |
| Protein Shake | | dairy flavor, caramelized | |
| (with reb a) | | flavor | |
| Maple Brown | 175 ppm | Sweet taste, bitter taste, | Salt taste, maple flavor, |
| Sugar | | total flavor, oat flavor, | brown paper flavor |
| Oatmeal | | caramelized flavor, | |
| | | brown sugar flavor, | |
| | | solvent flavor | |
| 50% Reduced | 250 ppm | Sweet taste, caramelized | Poppyseed flavor |
| Sugar Lemon | | flavor, lemon flavor, | |
| Poppyseed | | solvent flavor | |
| Muffins (with | | | |
| reb A) | | | |

As can be seen from the above table, the steviol glycoside composition was able to increase desirable flavors across a wide spectrum and reduce off flavors such as brown paper. This is unexpected, as most taste modifying agents have a narrow application range.

TABLE 3
Sensory Analysis Results.

| | | Significantly increased | Significantly reduced |
|---|---|---|---|
| Product type | Samples | flavors (95% CI) | flavors (95% CI) |
| Ketchup | Control: 30% | SG composition | None |
| | sodium reduced | enhanced the perception | |
| | ketchup was | of Acidic flavor, salt taste, | |
| | compared to | tomato flavor and overall | |
| | 30% sodium | flavor | |
| | reduced ketchup | | |
| | with 40 ppm of | | |
| | SG composition | | |
| Ketchup | Control Sodium | SG composition | |
| | Free Ketchup | increased the overall | |
| | with 0.2% KCl | flavor and modified the | |
| | (potassium | sensory profile by | |
| | chloride) | enhancing perception of | |
| | compared to | salt. It increased the | |
| | Sodium Free | perception of acidic | |
| | ketchup with | flavor | |
| | 0.2% KCl | | |
| | (potassium | | |
| | chloride) and 40 | | |
| | ppm of SG | | |
| | composition | | |
| Broth | 20% Sodium | The reduced salt with SG | |
| | Reduced | composition maintained | |
| | Chicken Broth | salt taste, boosted savory | |
| | compared to 20% | flavor and enhanced | |
| | Sodium Reduced | chicken fat flavor | |
| | Chicken Broth | | |
| | with 40 ppm of | | |
| | SG composition | | |
| Broth | Sodium Reduced | Overall SG composition | Astringency |
| | Chicken Broth | combined with KCL | |
| | (0.56% salt + | enhanced overall flavor, | |
| | 0.2% KCl | chicken fat flavor and | |
| | compared to | maintained salt taste | |
| | Sodium Reduced | | |
| | Chicken Broth | | |
| | (0.56% salt + | | |
| | 0.2% KCl 40 | | |
| | ppm of SG | | |
| | composition) | | |

In this study, SG composition, when used below its sweetness threshold, was shown to possess flavor modifying properties in these additional categories. In particular, as can be seen from the above table, the steviol glycoside composition was able to increase desirable flavors like sweet taste, acidic flavor, salt taste, chicken fat flavor, notes across the savory applications.

This suggests that SG composition can act as a flavoring substance with flavor modifying properties (FMP) when used at a level below its sweetness threshold and offers the potential to allow a 20-30% sodium reduction in savory applications with minimal change in sensorial profile.

While the principles of the invention have been set out above in connection with specific embodiments, it is to be understood that this description is merely made by way of example and not as a limitation of the scope of protection, which is determined by the appended claims.

We claim:

1. A food or beverage product comprising a steviol glycoside composition, said composition comprising 40-48 wt % rebaudioside A (reb A), 17-20 wt. % stevioside, and 11-13 wt. % rebaudioside C (reb C) based on the total amount of steviol glycosides in the food or beverage product, wherein the steviol glycoside composition is present in an amount below its sweetness threshold.

2. The food or beverage product according to claim 1, wherein said steviol glycoside composition further comprises rebaudioside B (reb B) and/or rebaudioside F (reb F).

3. The food or beverage product according to claim 1, wherein said steviol glycoside composition further comprises 3-5 wt. % rebaudioside B (reb B) and/or 2.5-3.5 wt. % rebaudioside F (reb F) based on the total amount of steviol glycosides in the food or beverage product.

4. The food or beverage product according to claim 1, wherein said steviol glycoside composition further comprises rebaudioside D (reb D) and/or rebaudioside M (reb M).

5. The food or beverage product according to claim 1, further comprising 1-2.5 wt. % of rebaudioside D (reb D) and/or 1-2.5 wt % rebaudioside M (reb M) based on the total amount of steviol glycosides in the food or beverage product.

6. The food or beverage product according to claim 1, wherein said steviol glycoside composition further comprises one or more further steviol glycosides.

7. The food or beverage product according to claim 1, wherein the steviol glycoside composition is present above about 20 ppm.

8. The food or beverage product according to claim 1, wherein the steviol glycoside composition is present below about 500 ppm.

9. (canceled)

10. (canceled)

11. The food or beverage product according to claim 1, further comprising one or more further additives selected from the group of flavors, flavorings with modifying properties, flavor enhancers, acidulants, natural fruit extracts, natural vegetable extracts, seasonings, herbs, spices, etc, more preferably one or more flavorings with modifying properties in an amount below their sweetness level, even more preferably erythritol; sodium gluconate; rare sugars such as allulose, tagatose, allose, cellobiose; glucosylated glycosides such as mogrosides, sesaminol glycosides, glucosylated steviol glycosides.

12. A method of preparing a food or beverage product comprising including in said food or beverage product a composition comprising 40-48 wt % rebaudioside A (reb A), 17-20 wt. % stevioside, and 11-13 wt. % rebaudioside C (reb C) based on the total amount of steviol glycosides in the food or beverage product, wherein the steviol glycoside composition is present in an amount below its sweetness threshold.

13. The method according to claim 12, wherein said steviol glycoside composition further comprises rebaudioside B (reb B) and/or rebaudioside F (reb F).

14. The method according to claim 12, wherein said steviol glycoside composition further comprises 3.5-5 wt. % rebaudioside B (reb B) and/or 2.5-3.5 wt. % rebaudioside F (reb F).

15. The method according to claim 12, wherein said steviol glycoside composition further comprises rebaudioside D (reb D) and/or rebaudioside M (reb M).

16. The method according to claim 12, wherein said steviol glycoside composition further comprises 1-2.5 wt. % of rebaudioside D (reb D) and/or 1-2.5 wt % rebaudioside M (reb M).

17. The method according to claim 12, further comprising adding one or more further additives selected from the group of flavors, flavorings with modifying properties, flavor enhancers, acidulants, natural fruit extracts, natural vegetable extracts, seasonings, herbs, spices, etc, more preferably, the method further comprises adding one or more flavorings with modifying properties in an amount below their sweetness level, even more preferably erythritol; sodium gluconate; rare sugars such as allulose, tagatose, allose, cellobiose; glucosylated glycosides such as mogrosides, sesaminol glycosides, glucosylated steviol glycosides.

18. The method according to claim 12, wherein flavor and/or taste of the food or beverage product is modified or enhanced.

19. The method according to claim 18, wherein off-flavor is reduced.

20. The method according to claim 18, wherein salt flavor is enhanced.

21. The method according to claim 18, wherein sweet flavor is enhanced.

22. The method according to claim 21, wherein the sweet flavor is a sweet aromatic flavor, preferably selected from the group consisting of caramelized flavor, maple flavor, sugary flavor, cocoa flavor, tropical flavor, and cotton candy flavor.

23.-35. (canceled)
